(19) United States
(12) Patent Application Publication
(10) Pub. No.: US 2018/0171812 A1
(43) Pub. Date: Jun. 21, 2018

(54) TURBOMACHINE SEALING ASSEMBLY

(71) Applicant: MTU Aero Engines AG, Muenchen (DE)

(72) Inventor: Jan Haegert, Gilching (DE)

(21) Appl. No.: 15/845,638

(22) Filed: Dec. 18, 2017

(30) Foreign Application Priority Data
Dec. 21, 2016 (DE) 102016225875.3

(51) Int. Cl. F01D 11/00; F16J 15/06

(52) U.S. Cl. CPC F01D 11/003; F05D 2260/98; F16J 15/067

(57) ABSTRACT

A sealing assembly for a turbomachine is provided, in particular for a gas turbine, having an annular groove G, in which at least one sealing ring (2) is located to seal a gap (S), at least one spiral ring (3) being located in the annular groove to axially support the sealing ring (2) against a first end face (11) of the annular groove.

This claims the benefit of German Patent Application DE 102016225875.3, filed Dec. 21, 2016 and hereby incorporated by reference herein.

The present invention relates to a sealing assembly for a turbomachine, in particular a gas turbine, a turbomachine, in particular a gas turbine, having the sealing assembly, as well as to a method for installing the sealing assembly.

### SUMMARY OF THE INVENTION

From in-plant practice, it is generally known to use split sealing rings to seal fixed oil lines in a turbomachine casing. In terms of structural design, the split sealing rings correspond to piston rings used for sealing movable pistons.

On the one hand, it is intended that such a sealing ring engage as far as possible by the inner diameter thereof into an annular groove to enlarge an axial stop surface and thereby minimize a loading and thus wear of the sealing ring and the annular groove.

On the other hand, it is intended that the least possible widening of the sealing ring be required for the installation, in particular to facilitate the installation and/or to avoid excessively, in particular at least partially plastically or permanently deforming the sealing ring, and thereby improve the sealing performance thereof.

It is an object of the present invention to improve a sealing assembly of a turbomachine and, accordingly, the installation thereof.

The present invention provides a sealing assembly, a turbomachine having at least one sealing assembly described here and a method for installing the same.

In accordance with an embodiment of the present invention, a sealing assembly for a turbomachine, in particular for a gas turbine, in particular at least one sealing assembly of a turbomachine, in particular of a gas turbine, has an annular groove, in which exactly one or a plurality of sealing ring(s) is/are located, that seals/seal a gap, in particular a radial and/or annular gap, at least temporarily, in particular only temporarily or permanently and, as the case may be, is/are provided, in particular adapted and, accordingly, used for that purpose.

In accordance with an embodiment of the present invention, in the annular groove, exactly one or a plurality of spiral ring(s) is/are located that supports/support the sealing ring(s) axially at least temporarily, in particular only temporarily or permanently, against or at a first axial end face of the annular groove and, accordingly, via which the sealing ring(s) are able to be at least temporarily, in particular only temporarily or permanently, axially supported against or at a first axial end face of the annular groove and, as the case may be, is/are provided, in particular adapted and, accordingly, used for that purpose.

To this end, in an embodiment, the, or one of the, sealing ring(s) rests/rest at least temporarily, in particular only temporarily or permanently, axially directly or contactingly against the, or one of the, spiral ring(s), and/or the, or one of the, spiral ring(s) rests/rest at least temporarily, in particular only temporarily or permanently, axially directly and, accordingly, contactingly against the first (axial) end face of the annular groove; in an embodiment, flat, in particular (in each case) over at least 15%, in particular at least 25%, in particular at least 50% of the (axial) end face thereof and, accordingly, (in each case) is provided, in particular adapted for that purpose.

In an embodiment, one or more further sealing rings may be (axially) supported via this one sealing ring and this one spiral ring; in an embodiment additionally via one or a plurality of further spiral rings, at least temporarily, in particular only temporarily, or permanently, against the first (axial) end face of the annular groove and, accordingly, be adapted for that purpose. Additionally or alternatively, (in each case) one or more further spiral rings may also be (axially) located between a second (axial) end face of the annular groove (axially) opposite the first (axial) end face and the, or a, sealing ring proximate thereto and/or between two or more sealing rings.

In an embodiment, directional indications refer to the annular groove, as is customary in the art, so that, in an embodiment, an axial direction is orthogonal (oriented orthogonally) to a circumference of the annular groove and, accordingly, a radial direction is orthogonal (oriented orthogonally) to the circumference of the annular groove and the axial direction.

In an embodiment, the annular groove features an end face and, accordingly, the second (axial) end face (axially) opposite the first (axial) end face, and a (radial) groove base joining the two end faces. In an embodiment, the first and/or second end face may be closed or (in each case) feature one or a plurality of channels, in particular grooves to an adjoining circumferential surface.

In an embodiment, the annular groove features an at least substantially constant (axial) groove width and/or (radial) groove depth, which, in particular, may simplify the manufacture. In an embodiment, the annular groove extends rotationally symmetrically (to the axial direction) and, in a further embodiment, annularly; in another embodiment, in a spiral shape or wave shape and, as the case may be, meander shape which, in each case, may enhance a sealing performance, in particular.

In an embodiment, the spiral ring(s) may enlarge an axial stop surface for supporting the sealing ring, or one or a plurality thereof, and thereby reduce a loading, in particular surface pressure and/or notch effect, and consequently, in an embodiment, wear of the sealing ring(s) and/or annular groove; at the same time, a widening required for or during the installation is advantageously reduced in an embodiment, thereby facilitating the installation and/or lessening a deformation of the sealing ring, or of one or of a plurality thereof, and thus making it possible to enhance a sealing performance.

In an embodiment, the sealing assembly features an, in particular radially opposite wall that bounds the (annular) gap, in particular radially outwardly; in an embodiment, the annular groove and the wall being fixed relative to each other, in particular fixed in position, at least during (normal) operation of the turbomachine and/or at least substantially, in particular non-destructively or destructively detachably.

Thus, in an embodiment, in particular a stationary or fixed gap of a turbomachine may be sealed, in particular by one or a plurality of sealing ring(s), which correspond(s) to piston rings, as known for sealing movable pistons and, accordingly, the annular grooves thereof.

In an embodiment, the annular groove is located on a duct having a channel that conveys fluid, in particular oil, or is provided, in particular adapted and, accordingly, used for that purpose, (“fluid channel”), thus, in particular, on an oil duct of the turbomachine.

This is an especially advantageous use of a sealing assembly according to the present invention.

In an embodiment, the, or one or a plurality of the, spiral ring(s) features/feature (in each case) at least two, in particular at least three, and/or at most five, in particular, at most, four, axially stacked spiral windings or (axial) layers. Additionally or alternatively, in an embodiment, the, or one or a plurality of the, spiral ring(s) is/are formed (in each case), in particular manufactured in one piece.

In an embodiment, this makes it possible to realize an advantageous support of the sealing ring(s).

In an embodiment, the, or one or a plurality of the, sealing ring(s) is/are each split, in particular in the manner generally known for piston rings. Additionally or alternatively, in an embodiment, the, or one or a plurality of the, sealing ring(s) is/are each formed, in particular manufactured in one piece.

In an embodiment, this makes it possible to (further enhance) the installation and/or sealing performance.

In an embodiment, the, or one or a plurality of the, sealing ring(s) and/or the, or one or a plurality of the, spiral ring(s) is/are manufactured from the same material. This makes it especially possible to enhance the dynamics of the seal and/or the wear thereof.

In an embodiment, the, or one or a plurality of the, sealing ring(s) and/or the, or one or a plurality of the, spiral ring(s) are/is manufactured from different material. In an embodiment, this makes it possible to enhance the functionalities of the rings, in particular a sealing performance of the (particular) sealing ring and/or supporting action of the (particular) spiral ring.

Additionally or alternatively, the, or one or a plurality of the, sealing ring(s) and/or the, or one or a plurality of the, spiral ring(s) (in each case) contain(s) a metal; in an embodiment, it/they is/are made (in each case) therefrom. In particular, the, or one or a plurality of the, sealing ring(s) may contain, in particular be composed of Nitronic 60, Hs25 or a similar metal and/or the, or one or a plurality of the, spiral ring(s) may contain IN625 or a similar metal, in particular be made of the same.

In an embodiment, this makes it possible to enhance the functionality of the (particular) ring, in particular a sealing performance of the (particular) sealing ring and/or the supporting action of the (particular) spiral ring.

In an embodiment, a circumference, in particular outer diameter of a first circumferential, in particular lateral surface that adjoins the first end face that bounds the gap, in particular radially inwardly, is smaller than a circumference, in particular outside diameter of a second circumferential, in particular lateral surface that bounds the gap, in particular radially inwardly, that adjoins the, or a second, end face of the annular groove (axially) opposite the first end face, in an embodiment by at least 2%, in particular at least 5%, in particular at least 10%, and/or, at most, by 50%, in particular, at most, by 25%, in particular, at most, by 15% of the (outer) circumference, in particular outer diameter, of the first or second end face or circumferential surface.

Additionally or alternatively, in an embodiment, the, or a first circumferential, in particular lateral surface that adjoins the first end face and that bounds the gap, in particular radially inwardly, and/or the, or a second circumferential, in particular lateral surface that adjoins the, or a second, end face that is (axially) opposite the first end face and that bounds the gap, in particular radially inwardly are/is formed to be rotationally symmetric, in particular conical or cylindrical.

In an embodiment, the sealing ring(s) and/or spiral ring(s) are slid from or onto the first circumferential surface, in particular, one after another, from the first to the second end face of the annular groove, or located in the same.

In an embodiment, this makes it possible to (further) enhance an installation in each case, in particular in combination.

In an embodiment, an, in particular minimum, maximum and/or medium inner width, in particular an inner circumference, in particular inner diameter, of the, or of one or a plurality of the, sealing ring(s) located in the annular groove is smaller (in each case) than an, in particular minimum, maximum and/or medium outer width, in particular an outer circumference, in particular outer diameter of the spiral ring, or of one or a plurality of the spiral rings located in the annular groove, in particular (in each case) by at least 1%, in particular at least 5%, in particular at least 10%, and/or, at most, by 50%, in particular, at most, by 25%, in particular, at most, by 15%, of this inner or outer width.

Additionally or alternatively, in an embodiment, an, in particular minimum, maximum and/or medium inner width, in particular an inner circumference, in particular inner diameter, of the, or of one or a plurality of the, sealing ring(s) located in the annular groove is smaller (in each case) than an, in particular minimum, maximum and/or medium outer width, in particular an outer circumference, in particular outer diameter of the second end face of the annular groove opposite the first end face, in particular (in each case) by at least 1%, in particular at least 5%, in particular at least 10%, and/or, at most, by 50%, in particular, at most, by 25%, in particular, at most, by 15%, of this inner or outer width.

Additionally or alternatively, in an embodiment, an, in particular minimum, maximum and/or medium inner width, in particular an inner circumference, in particular inner diameter, of the, or of one or a plurality of the, spiral ring(s) located in the annular groove is smaller (in each case) than an, in particular minimum, maximum and/or medium outer width, in particular an outer circumference, in particular outer diameter of the first end face of the annular groove, in particular (in each case) by at least 1%, in particular at least 5%, in particular at least 10%, and/or, at most, by 50%, in particular, at most, by 25%, in particular, at most, by 15%, of this inner or outer width. In an embodiment, the, or one or a plurality of the, spiral ring(s) located in the annular groove rests/rest on the groove base of the annular groove.

Additionally or alternatively, in an embodiment, an, in particular minimum, maximum and/or medium inner width, in particular an inner circumference, in particular inner diameter, and/or an, in particular minimum, maximum and/or medium outer width, in particular an outer circumference, in particular an outer diameter of the, or of one or a plurality of the, spiral ring(s) located in the annular groove is/are smaller (in each case), or at least substantially equal to or larger than an, in particular minimum, maximum and/or medium outer width, in particular an outer circumference, in particular outer diameter of the second end face of the annular groove, in particular (in each case) by at least 1%, in particular at least 5%, in particular at least 10%, and/or, at most, by 50%, in particular, at most, by 25%, in particular, at most, by 15%, of this inner or outer width.

Additionally or alternatively, in an embodiment, an, in particular minimum, maximum and/or medium inner width, in particular an inner circumference, in particular inner diameter, and/or an, in particular minimum, maximum and/or medium outer width, in particular an outer circumference, in particular an outer diameter of the, or of one or a plurality of the, sealing ring(s) located in the annular groove is smaller (in each case), at least substantially equal to or larger than an, in particular minimum, maximum and/or medium outer width, in particular an outer circumference, in particular outer diameter of the first end face of the annular groove, in particular (in each case) by at least 1%, in particular at least 5%, in particular at least 10%, and/or, at most, by 50%, in particular, at most, by 25%, in particular, at most, by 15%, of this inner or outer width. In an embodiment, the, or one or a plurality of the, sealing ring(s) located in the annular groove rests/rest against the wall opposite the annular groove or bounding the gap.

In an embodiment, the, or one or a plurality of the, spiral ring(s) located in the annular groove is/are axially resiliently compressed and/or radially resiliently widened.

In an embodiment, this makes it possible in each case to (further) enhance the weight, wear, installation, and/or sealing performance, in particular in combination.

In an embodiment, the, or one or a plurality of the, spiral ring(s) is/are located on a side of a higher pressure to be sealed of the sealing ring, or of one or a plurality thereof. In an embodiment, this makes it possible to (further) enhance a sealing performance.

In an embodiment, the, or one or a plurality of the, spiral ring(s) is/are located on a side of a lower pressure of the sealing ring, or of one or a plurality of the sealing rings, to be sealed. In an embodiment, this makes it possible to (further) enhance an axial supporting of the sealing ring(s) by the spiral sealing ring(s).

In an embodiment, the gap is bounded, in particular radially outwardly by a casing, in particular a turbine center frame of the turbomachine.

This is an especially advantageous use of a sealing assembly according to the present invention.

In an embodiment of the present invention, the sealing ring(s) is/are located in the annular groove to seal the gap, in particular under little, in particular only temporary resilient widening; the, or one or a plurality of the, spiral ring(s) being located (in each case) in the annular groove, in particular before or subsequently to the supporting, or axial supporting thereof, in particular under little, in particular only temporary resilient widening.

In an embodiment, this makes it possible to (further) enhance an installation.

### BRIEF DESCRIPTION OF THE DRAWING

Further advantageous embodiments of the present invention will become apparent from the dependent claims and the following description of preferred embodiments. To this end, in partially schematic form, the only:

FIG. 1 shows a sealing assembly of a turbomachine in accordance with an embodiment of the present invention.

### DETAILED DESCRIPTION

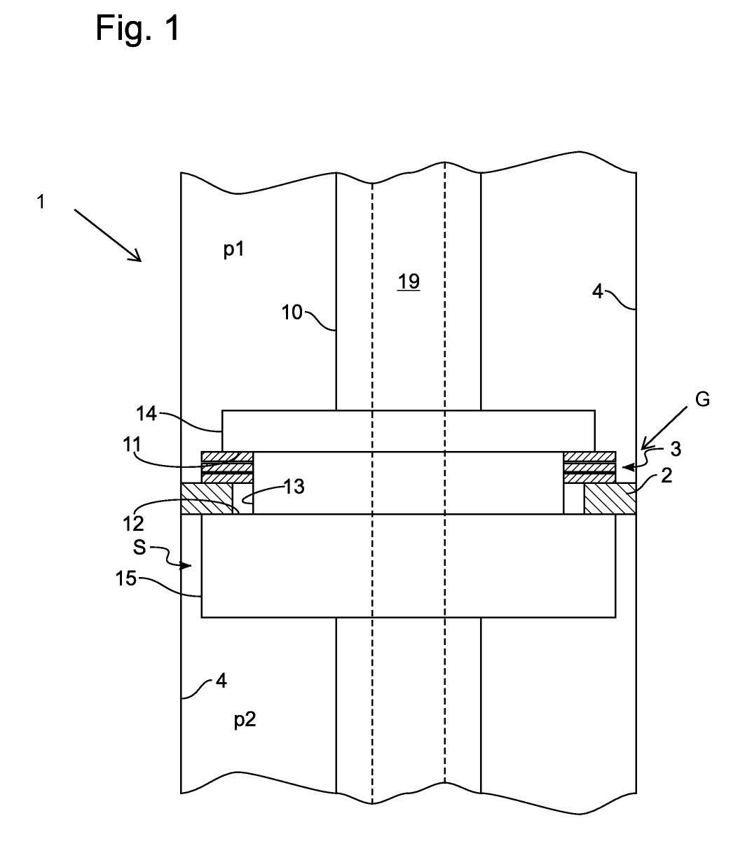

FIG. 1 shows a sealing assembly of a turbomachine 1, shown schematically, in accordance with an embodiment of the present invention in an axial section.

On an oil duct 10 of the turbomachine 1 having a fluid channel 19, the sealing assembly features an annular groove G that includes a first axial end face 11, a second axial end face 12 opposing the same axially (vertically in FIG. 1), and a groove base 13 joining these end faces 11, 12.

Located in annular groove G is a sealing ring 2 that seals a radial annular gap S to a radially outer wall 4 of a casing of turbomachine 1.

Also located in annular groove G is a spiral ring 3 that axially supports sealing ring 2 against or at first end face 11 of the annular groove.

To this end, sealing ring 2 rests at least temporarily axially directly or contactingly against spiral ring 3, which, in turn, rests axially directly or contactingly, flat against first end face 11.

Annular groove G and wall 4 are fixed relative to each other.

Spiral ring 3 has three axially stacked spiral windings or (axial) layers and is made in the exemplary embodiment in one piece of IN625 or of a similar metal.

In the manner generally known for piston rings, sealing ring 2 is split and formed in the exemplary embodiment in one piece from Nitronic 60, Hs25 or a similar metal.

A circumference of a cylindrical first lateral surface 14 that adjoins first end face 11 and bounds gap S radially inwardly is smaller than a circumference of a second lateral surface 15 that bounds gap S radially inwardly and adjoins second end face 12 that axially opposes first end face 11.

Sealing ring 2 and spiral ring 3 are slid one after another from or onto the (smaller) first circumferential surface 14 in the axial direction from the first to the second end face of the annular groove (from top to bottom in FIG. 1) or are located in the same.

An inner diameter of sealing ring 2 located in the annular groove is smaller than an outer diameter of spiral ring 3 located in the annular groove and also smaller than an outer diameter of second end face 12 of the annular groove that opposes first end face 11.

In the exemplary embodiment, an outer diameter of spiral ring 3 located in the annular groove is substantially equal to the outer diameter of second end face 15. In a modification (not shown), it may also be smaller or larger.

In addition, in the exemplary embodiment, the inner diameter of sealing ring 2 located in the annular groove is smaller than the outer diameter of first end face 11 of the annular groove. In a modification (not shown), it may also be at least substantially the same or larger.

Spiral ring 3 located in the annular groove rests on groove base 13; sealing ring 2 located in the annular groove rests against wall 4 opposing the annular groove and, accordingly, bounding gap S.

Spiral ring 3 located in the annular groove is axially resiliently compressed.

Spiral ring 3 is located on a side of a higher pressure p1 to be sealed (p1>p2) of sealing ring 2. In a modification, it may also be located on a side of a lower pressure p1 to be sealed (p1<p2) of sealing ring 2.

Although exemplary embodiments are explained in the preceding description, it should be noted that numerous modifications are possible. It should also be appreciated that the exemplary embodiments are merely examples, and are in no way intended to restrict the scope of protection, the uses or the design. Rather, the foregoing description provides one skilled in the art with a guideline for realizing at least one exemplary embodiment; various modifications being possible, particularly with regard to the function and location of the described components, without departing from the scope of protection as is derived from the claims and the combinations of features equivalent thereto.

### REFERENCE NUMERAL LIST

10 oil duct
11 first end face of the annular groove
12 second end face of the annular groove
13 annular base
14 first lateral surface
15 second lateral surface
19 fluid channel
2 sealing ring
3 spiral ring
4 (casing) wall
S gap
p1, p2 pressure sides to be sealed

What is claimed is:

1. A sealing assembly comprising:
an annular groove;
at least one sealing ring for sealing a gap being located in the annular groove;
at least one spiral ring being located in the annular groove to axially support the sealing ring against a first end face of the annular groove.

2. The sealing assembly as recited in claim 1 wherein a wall bounds the gap, the annular groove and the wall being fixed relative to each other.

3. The sealing assembly as recited in claim 1 wherein the annular groove is located on a duct having a fluid channel.

4. The sealing assembly as recited in claim 1 wherein the spiral ring has at least two, and/or, at most, five axially stacked spiral windings.

5. The sealing assembly as recited in claim 1 wherein the sealing ring is split.

6. The sealing assembly as recited in claim 1 wherein the sealing ring and the spiral ring are manufactured from a same material.

7. The sealing assembly as recited in claim 1 wherein the sealing ring and the spiral ring are manufactured from different materials.

8. The sealing assembly as recited in claim 1 wherein the sealing ring or the spiral ring contain metal.

9. The sealing assembly as recited in claim 1 wherein a circumference of a first circumferential surface adjoining the first end face and bounding the gap is smaller than a circumference of a second circumferential surface bounding the gap and adjoining a second end face of the annular groove opposite the first end face.

10. The sealing assembly as recited in claim 1 wherein an inner diameter of the sealing ring located in the annular groove is smaller than an outer diameter of the spiral ring located in the annular groove.

11. The sealing assembly as recited in claim 1 wherein an inner diameter of the sealing ring located in the annular groove is smaller than an outer diameter of a second end face of the annular groove that opposes the first end face.

12. The sealing assembly as recited in claim 1 wherein an inner diameter of the spiral ring located in the annular groove is smaller than an outer diameter of the first end face of the annular groove.

13. The sealing assembly as recited in claim 1 wherein the spiral ring located in the annular groove is axially resiliently compressed or radially resiliently widened.

14. The sealing assembly as recited in claim 1 wherein the spiral ring is located on a side of a higher or lower pressure to be sealed by the sealing ring.

15. A turbomachine comprising at least one sealing assembly as recited in claim 1.

16. A gas turbine comprising the turbomachine as recited in claim 15.

17. A turbomachine as recited in claim 15 wherein the gap is bounded by a casing of the turbomachine.

18. A method for installing a sealing assembly as recited in claim 1 comprising locating the sealing ring in the annular groove to seal the gap; and locating the spiral ring in the annular groove to axially support the sealing ring.

19. The method as recited in claim 18 wherein the locating of the of the sealing ring occurs with substantially no resilient widening; and, before or subsequently to the locating of the sealing ring, the spiral ring is located to axially support the sealing ring under substantially no resilient widening of the spiral ring.
